(19) United States
(12) Patent Application Publication
(10) Pub. No.: US 2025/0096979 A1
(43) Pub. Date: Mar. 20, 2025

(54) APPROACHES FOR BACKSCATTERING

(71) Applicant: Telefonaktiebolaget LM Ericsson (publ), Stockholm (SE)

(72) Inventors: Miguel LOPEZ, Aachen (DE); Guido Roland HIERTZ, Aachen (DE); Leif WILHELMSSON, Lund (SE)

(21) Appl. No.: 18/727,163

(22) PCT Filed: Jan. 14, 2022
(86) PCT No.: PCT/EP2022/050729

§ 371 Date: Jul. 8, 2024

(51) Int. Cl. H04L 5/00

(52) U.S. Cl. CPC H04L 5/0053; H04L 5/0007

(57) ABSTRACT

Methods, signal packets, orthogonal frequency division multiplexing (OFDM) transmitters, backscattering devices and corresponding computer program products are disclosed. According to one aspect, a signal packet is provided for transmission by an OFDM transmitter of to illuminate a backscatter device. The signal packet includes an initial portion to trigger circuitry of the backscatter device for operation, and to transfer energy to the backscatter device. The signal packet includes a data carrying portion providing control information. The data carrying portion includes to the backscatter device regarding backscatter transmission, and an illuminating portion to cause backscatter transmission within a duration of the illuminating portion in accordance with the control information. Also disclosed are a method for an OFDM transmitter and a method for a backscatter device.

### TECHNICAL FIELD

The present disclosure relates generally to the field of backscattering. More particularly, it relates to control of backscattering characteristics.

### BACKGROUND

A device comprising a backscatter radio may be referred to as a backscatter device. One example of a backscatter device is a radio frequency identification (RFID) tag. Generally, backscatter radio technology is suitable for ultra-low power devices, e.g., some Internet-of-Things (IoT) devices.

One typical feature of a backscatter device is that it does not generate the radio frequency (RF) carrier for backscatter transmission. Thus, a backscatter radio typically delegates generation of the RF carrier to a device other than the backscatter device. A device that generates the RF carrier for a backscatter device may be referred to as an illuminating node, and the signal providing the RF carrier may be referred to as an illuminating signal.

This approach may be beneficial in terms of power consumption of the backscatter device. For example, one or more power-hungry components normally present in radio devices (e.g., power amplifiers, filters, mixers, etc.) may not be required in the backscatter device. Thereby, the power consumption of the backscatter device may be significantly reduced compared to traditional radio devices (e.g., by orders of magnitude).

A problem with backscatter devices using an illuminating node for RF carrier generation is that the backscatter transmission may be interfered by the illuminating signal. This may be particularly cumbersome since the illuminating signal may be transmitted with higher power than the backscatter transmission. The problem is relevant for a scenario where the illuminating node is also receiving the backscatter transmission (monostatic scenario), as well as for a scenario where the backscatter transmission is received by a device/node other than the illuminating node (bistatic scenario).

Therefore, there is a need for alternative approaches to backscattering.

For example, there is a need for mitigating and/or avoiding interference caused by the illuminating signal and experienced at reception of the backscatter transmission.

### SUMMARY

It should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an arrangement is referred to herein, it is to be understood as a physical product; e.g., an apparatus. The physical product may comprise one or more parts, such as controlling circuitry in the form of one or more controllers, one or more processors, or the like.

It is an object of some embodiments to solve or mitigate, alleviate, or eliminate at least some of the above or other disadvantages.

A first aspect is a method for an orthogonal frequency division multiplex (OFDM) transmitter. The method comprises transmitting a signal packet for illumination of a backscatter device. The signal packet comprises an initial portion configured to trigger circuitry of the backscatter device for operation, and configured to transfer energy to the backscatter device, at least one data carrying portion configured to provide control information to the backscatter device regarding backscatter transmission, and at least one illuminating portion configured to cause backscatter transmission by the backscatter device within a duration of the illuminating portion and in accordance with the provided control information.

In some embodiments, the signal packet comprises two or more data carrying portions, wherein each data carrying portion is directly followed by a respective illuminating portion.

In some embodiments, the initial portion comprises a preamble portion and/or an additional illuminating portion.

In some embodiments, the preamble portion and the additional illuminating portion are configured to transfer an amount of energy to the backscatter device, wherein the amount of energy exceeds an energy threshold.

In some embodiments, the preamble portion comprises a legacy preamble.

In some embodiments, the preamble portion is configured to cause other OFDM transmitters to defer from transmission during the transmission of the signal packet by the OFDM transmitter.

In some embodiments, only a first signal packet of a transmission opportunity (TXOP) comprises the preamble portion.

In some embodiments, any one or more illuminating portion is further configured to transfer energy to the backscatter device.

In some embodiments, any one or more illuminating portion comprises at least one continuously active sub-carrier.

In some embodiments, any one or more illuminating portion extends only over a subset of OFDM signal frequency resources.

In some embodiments, the control information provided by the data carrying portion comprises one or more of: backscatter scheduling information, a backscatter grant, and an identity indicator of the backscatter device.

In some embodiments, the control information provided by the data carrying portion includes a frequency indicator for the backscatter transmission.

In some embodiments, the frequency indicator for the backscatter transmission is configured to cause the backscatter transmission and its corresponding illuminating portion to be non-overlapping in frequency.

In some embodiments, the frequency indicator for the backscatter transmission is configured to cause the backscatter transmission to coincide with one or more OFDM signal sub-carriers.

In some embodiments, the frequency indicator for the backscatter transmission defines a frequency shift in relation to an illuminating signal of the corresponding illuminating portion.

In some embodiments, the control information provided by the data carrying portion comprises time synchronization information.

In some embodiments, the control information provided by the data carrying portion specifies one or more timing parameters for a transmission instance of the backscatter transmission.

In some embodiments, the one or more timing parameters for a transmission instance of the backscatter transmission include one or more of: a transmission instance start time, a transmission instance end time, a transmission instance duration.

In some embodiments, the one or more timing parameters for a transmission instance of the backscatter transmission define the transmission instance as coinciding with one or more OFDM symbols.

In some embodiments, the data carrying portion provides the control information using one or more of: frequency shift keying (FSK), on-off keying (OOK), and Manchester coding (MC).

In some embodiments, the data carrying portion is further configured to transfer energy to the backscatter device.

In some embodiments, the data carrying portion comprises at least one continuously active sub-carrier configured to transfer energy to the backscatter device.

In some embodiments, the data carrying portion extends only over a subset of OFDM signal frequency resources.

In some embodiments, the backscatter device comprises one or more of: an Internet-of-Things (IoT) device, a radio frequency identification (RFID) device, a near field communication (NFC) device, a far field communication (FFC) device, and a dedicated short range communication (DSRC) device.

In some embodiments, the OFDM transmitter is compliant with one or more of: IEEE 802.11 standardization; and third generation partnership project (3GPP) standardization.

In some embodiments, the OFDM transmitter is an OFDM transceiver capable of simultaneous transmission and reception in a same channel, wherein the simultaneous transmission and reception use different OFDM signal frequency resources within the channel.

A second aspect is a method for a backscatter device. The method comprises receiving a signal packet from an orthogonal frequency division multiplex (OFDM) transmitter. The signal packet comprises an initial portion configured to trigger circuitry of the backscatter device for operation, and configured to transfer energy to the backscatter device, at least one data carrying portion configured to provide control information to the backscatter device regarding backscatter transmission, and at least one illuminating portion configured to cause backscatter transmission by the backscatter device within a duration of the illuminating portion and in accordance with the provided control information.

In some embodiments, any one or more illuminating portion and/or the data carrying portion is further configured to transfer energy to the backscatter device.

In some embodiments, the method further comprises harvesting energy from at least the initial portion.

In some embodiments, the method further comprises performing time synchronization based on time synchronization information comprised in the control information provided by the data carrying portion.

In some embodiments, the method further comprises performing backscatter transmission within the duration of the illuminating portion.

In some embodiments, the backscatter transmission is performed using one or more of: frequency shift keying (FSK), on-off keying (OOK), and Manchester coding (MC).

In some embodiments, the backscatter transmission is performed in accordance with a frequency indicator included in the control information provided by the data carrying portion.

In some embodiments, performing the backscatter transmission comprises applying a frequency shift in relation to an illuminating signal of the illuminating portion.

In some embodiments, the backscatter transmission is performed according to one or more timing parameters for a transmission instance specified by the control information provided by the data carrying portion.

In some embodiments, the backscatter device comprises one or more of: an Internet-of-Things (IoT) device, a radio frequency identification (RFID) device, a near field communication (NFC) device, a far field communication (FFC) device, and a dedicated short range communication (DSRC) device.

In some embodiments, the OFDM transmitter is compliant with one or more of: IEEE 802.11 standardization; and third generation partnership project (3GPP) standardization.

In some embodiments, the OFDM transmitter is an OFDM transceiver capable of simultaneous transmission and reception in a same channel, wherein the simultaneous transmission and reception use different OFDM signal frequency resources within the channel.

A third aspect is a computer program product comprising a non-transitory computer readable medium, having thereon a computer program comprising program instructions. The computer program is loadable into a data processing unit and configured to cause execution of the method according to any of the first and second aspects when the computer program is run by the data processing unit.

A fourth aspect is a signal packet for transmission by an orthogonal frequency division multiplex (OFDM) transmitter for illumination of a backscatter device. The signal packet comprises an initial portion configured to trigger circuitry of the backscatter device for operation, and configured to transfer energy to the backscatter device, at least one data carrying portion configured to provide control information to the backscatter device regarding backscatter transmission, and at least one illuminating portion configured to cause backscatter transmission by the backscatter device within a duration of the illuminating portion and in accordance with the provided control information.

A fifth aspect is an apparatus for an orthogonal frequency division multiplex (OFDM) transmitter. The apparatus comprises controlling circuitry configured to cause transmission of a signal packet for illumination of a backscatter device. The signal packet comprises an initial portion configured to trigger circuitry of the backscatter device for operation, and configured to transfer energy to the backscatter device, at least one data carrying portion configured to provide control information to the backscatter device regarding backscatter transmission, and at least one illuminating portion configured to cause backscatter transmission by the backscatter device within a duration of the illuminating portion and in accordance with the provided control information.

In some embodiments, the controlling circuitry is configured to cause performance of a method in accordance with the first aspect and/or wherein the signal packet is a signal packet according to the first fourth.

A sixth aspect is an orthogonal frequency division multiplex (OFDM) transmitter comprising the apparatus of the fifth aspect.

A seventh aspect is a radio access node comprising the OFDM transmitter of the sixth aspect.

An eighth aspect is a user device comprising the OFDM transmitter of the sixth aspect.

A ninth aspect is an apparatus for a backscatter device. The apparatus comprises controlling circuitry configured to cause reception of a signal packet from an orthogonal frequency division multiplex (OFDM) transmitter. The signal packet comprises an initial portion configured to trigger circuitry of the backscatter device for operation, and configured to transfer energy to the backscatter device, at least one data carrying portion configured to provide control information to the backscatter device regarding backscatter transmission, and at least one illuminating portion configured to cause backscatter transmission by the backscatter device within a duration of the illuminating portion and in accordance with the provided control information.

In some embodiments, the controlling circuitry is configured to cause performance of a method in accordance with the second aspect and/or wherein the signal packet is a signal packet according to the fourth aspect.

A tenth aspect is a backscatter device comprising the apparatus of the ninth aspect.

In some embodiments, any of the above aspects may additionally have features identical with or corresponding to any of the various features as explained above for any of the other aspects.

An advantage of some embodiments is that alternative approaches to backscattering are provided.

An advantage of some embodiments is that interference caused by the illuminating signal and experienced at reception of the backscatter transmission is mitigates and/or avoided.

An advantage of some embodiments is that no device specifically dedicated for illumination is required for illuminating the backscatter device.

An advantage of some embodiments is that no device specifically dedicated for backscatter reading is required for reception of the backscatter transmission.

An advantage of some embodiments is that an OFDM device (e.g., a Wi-Fi station; operating in accordance with an IEEE 802.11 standard) can be used as illuminating node and/or backscatter reader (i.e., receiver of backscatter transmission). For example, the OFDM device may be a partial in-band full duplex device; a.k.a. a sub-band full duplex device.

An advantage of some embodiments is that a simultaneous transmission and reception (STR) multi-link device (MLD)—which may, or may not, be an OFDM device—can be used as illuminating node and backscatter reader (i.e., receiver of backscatter transmission).

An advantage of some embodiments is that a single channel for OFDM signaling may suffice for conveying both the illuminating signal and the backscatter transmission.

An advantage of some embodiments is that coexistence with legacy devices (e.g., legacy OFDM devices) is enabled.

An advantage of some embodiments is that backscattering (e.g., RFID) may be provided without requiring dedicated backscatter readers.

An advantage of some embodiments is that transmission of the illuminating signal and/or reception of the backscatter transmission may be achieved by re-use of already existing functional units (hardware and/or software) of an OFDM-transceiver and/or an STR MLD.

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1 is a flowchart illustrating example method steps according to some embodiments;

FIG. 2 is a flowchart illustrating example method steps according to some embodiments;

FIG. 3 is a signaling diagram illustrating example signaling according to some embodiments;

FIG. 4 is a schematic drawing illustrating example frequency shifts according to some embodiments;

FIG. 5 is a schematic block diagram illustrating an example frequency shifting arrangement according to some embodiments;

FIG. 6 is a schematic drawing illustrating an example signal packet according to some embodiments;

FIG. 7 is a schematic time-frequency grid illustrating an example signal packet structure according to some embodiments;

FIG. 8 is a schematic time-frequency grid illustrating an example signal packet structure and an example corresponding backscatter transmission according to some embodiments;

FIG. 9 is a schematic block diagram illustrating an example apparatus according to some embodiments;

FIG. 10 is a schematic block diagram illustrating an example apparatus according to some embodiments; and

FIG. 11 is a schematic drawing illustrating an example computer readable medium according to some embodiments.

### DETAILED DESCRIPTION

As already mentioned above, it should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

In the following, embodiments will be described that provide alternative approaches to backscattering. Particularly, some embodiments will be described for mitigating and/or avoiding interference caused by the illuminating signal and experienced at reception of the backscatter transmission. According to some embodiments, the alternative approaches comprise control of backscattering characteristics.

Various embodiments involve a backscatter device and a device configured to transmit a signal packet for illumination of the backscatter device. The device configured to transmit the signal packet for illumination of the backscatter device may, or may not, also be configured to receive the backscatter transmission resulting from the illumination.

The backscatter device may be any suitable backscatter device. Example backscatter devices include an Internet-of-Things (IoT) device, a radio frequency identification (RFID) device, a near field communication (NFC) device, a far field communication (FFC) device, and a dedicated short range communication (DSRC) device.

The device configured to transmit the signal packet for illumination of the backscatter device may be a multi-link device (MLD), such as, for example, a simultaneous transmission and reception (STR) multi-link device (MLD). A multi-link device may be particularly applicable as a device configured to both transmit the signal packet for illumination of the backscatter device and receive the backscatter transmission resulting from the illumination.

For example, an STR MLD may be defined as a device comprising at least two radio units (e.g., at least two IEEE 802.11 stations), wherein one (or more) radio unit can be configured for reception while another one (or more) radio unit is configured for transmission. In such a scenario, different channels are typically used for reception and transmission.

A non-limiting example of multi-link devices is defined (or is to be defined) in IEEE 802.11be standardization. According to that (or any other suitable) example, an MLD may be seen as a logical entity that has more than one affiliated station (e.g., the stations, STAs, of an MLD may share a logical medium access control, MAC, entity). Typically, each station of an MLD may have its own radio circuitry. As explained above, a multi-radio MLD may support simultaneous transmit and receive operation (i.e., STR). Thus, an MLD supporting STR may transmit in one RF channel and simultaneously receive in a different RF channel.

Alternatively or additionally, the device configured to transmit the signal packet for illumination of the backscatter device may be an orthogonal frequency division multiplex (OFDM) transmitter.

In some embodiments, the OFDM transmitter is an OFDM transceiver capable of simultaneous transmission and reception in a same channel, wherein the simultaneous transmission and reception use different OFDM signal frequency resources (e.g., different sub-carriers) within the channel. Such OFDM transceivers may be referred to as partial in-band full duplex devices or sub-band full duplex devices.

Typically, partial in-band full duplex functionality may be easier and/or less expensive to implement than full duplex functionality for simultaneous transmission and reception on the same frequency resource(s); while still enabling many of the advantages of full duplex.

A partial in-band full duplex device may be particularly applicable as a device configured to both transmit the signal packet for illumination of the backscatter device and receive the backscatter transmission resulting from the illumination.

The device configured to transmit the signal packet for illumination of the backscatter device may, for example, be compliant with IEEE 802.11 standardization and/or third generation partnership project (3GPP) standardization (e.g., fourth, fifth, or sixth generation standardization; 4G, 5G, 6G). However, it should be noted that some embodiments may be equally suitable for other types of devices (e.g. any suitable OFDM transmitter and/or any suitable MLD). Furthermore, it should be noted that application of some embodiments is not limited to classical OFDM situations. For example, some embodiments may be applicable for single carrier frequency division multiple access (SC-FDMA; a.k.a., Discrete Fourier Transform-spread-OFDM, DFT-s-OFDM).

Generally, the transmission of the signal packet for illumination of the backscatter device is not limited to principles of a particular link type. Contrarily, the transmission of the signal packet for illumination of the backscatter device may apply principles for uplink transmission, downlink transmission, device-to-device transmission, or any other suitable transmission.

The backscatter may use any suitable approach for performing backscatter transmission based on a radio frequency (RF) carrier generated by a device other than the backscatter device. For example, some backscattering devices may perform backscatter transmission by using an antenna mismatched to an incoming RF carrier, thereby reflecting (or backscattering) the incoming electromagnetic waves, and modulating the reflected electromagnetic waves in order to transmit information to a device configured to receive backscatter transmissions.

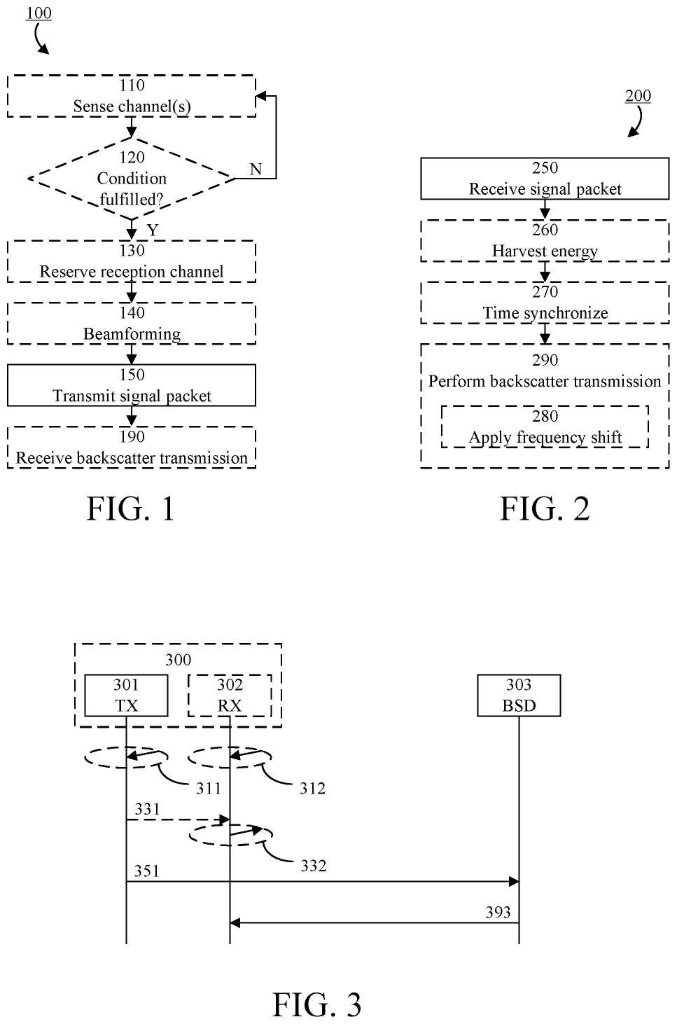

FIG. 1 illustrates an example method 100 according to some embodiments. The method 100 is for a device configured to transmit a signal packet for illumination of a (e.g., one or more) backscatter device. As mentioned above, a device configured to transmit a signal packet for illumination may be an OFDM transmitter and/or an STR MLD.

As illustrated by step 150, the method 100 comprises transmitting the signal packet for illumination of the backscatter device. The signal packet may have any suitable format. For example, the signal packet may correspond to the signal packet described later herein in connection with FIG. 6.

When the method 100 is performed by an OFDM transmitter, the signal packet is transmitted within a channel suitable for OFDM signaling. When the method 100 is performed by an STR MLD, the signal packet is transmitted within a transmission channel (e.g., a 20 MHz channel) of the MLD. As already implied, the transmission channel of the MLD may, or may not, be a channel suitable for OFDM signaling.

The signal packet is indicative of (e.g., comprises) control information regarding backscatter transmission. Hence, the signal packet is configured to provide the control information according to some embodiments.

For example, the control information (and/or other portions of the signal packet) may be provided using frequency shift keying (FSK), and/or on-off keying (OOK; e.g., multi-carrier OOK), and/or Manchester coding (MC).

Generally, OOK and FSK are modulation techniques well suited for processing by low power receivers. Furthermore, OOK and FSK are modulation techniques that can easily be implemented by means of an OFDM modulator.

The control information may include a frequency indicator for backscatter transmission. The frequency indicator is typically configured to cause the backscatter transmission and its corresponding illuminating portion to be non-overlapping in frequency.

When the method 100 is performed by an OFDM transmitter, the frequency indicator may be configured to cause the backscatter transmission to fall within, or outside of, the same channel as the signal packet.

When the method 100 is performed by an STR MLD, the frequency indicator may be configured to cause the backscatter transmission to fall within a reception channel (e.g., a 20 MHz channel) of the MLD. As already implied, the reception channel of the MLD may, or may not, be a channel suitable for OFDM signaling.

When the backscatter transmission falls within a channel suitable for OFDM signaling, the frequency indicator may be configured to cause the backscatter transmission to coincide with one or more OFDM signal sub-carriers of the channel. Alternatively, when the backscatter transmission falls within a channel suitable for OFDM signaling, the frequency indicator may be configured to cause the backscatter transmission to fall within a guard band of the channel.

The application of the frequency indicator contributes to mitigating and/or avoiding interference caused by the illuminating signal and experienced at reception of the backscatter transmission. For example, filtering may be applied by a receiver of the backscatter transmission to remove (or at least suppress) the corresponding illuminating signal. Alternatively or additionally, a receiver of the backscatter transmission configured for OFDM reception, may extract the backscatter transmission by considering only the corresponding portions (e.g., sub-carriers) of the channel.

Generally, the frequency indicator can have any suitable form. For example, the frequency indicator may specify one (or more) frequency range for the backscatter transmission and/or one (or more) center frequency for the backscatter transmission. The specification may be in absolute terms or relative terms. Furthermore, the specification may use any suitable frequency unit representation (e.g., Hertz, sub-carrier, RF channel, etc.).

In a typical example, the frequency indicator for the backscatter transmission defines a frequency shift in relation to an illuminating signal of the signal packet. For example, the frequency shift may be an integer multiple of a sub-carrier spacing to cause the backscatter transmission to coincide with one or more OFDM signal sub-carriers of the channel.

Alternatively or additionally, the control information may comprise backscatter scheduling information, and/or a backscatter grant, and/or an identity indicator of the backscatter device. Such control information may be suitable for controlling which backscatter device(s) are to use the signal packet illumination for backscatter transmission, and which are to not.

In some example scenarios, the signal packet reaches a plurality of backscatter devices simultaneously (or substantially simultaneously). The scheduling information and/or backscatter grant and/or identity indicator may be beneficial to avoid, or at least reduce the risk of, collision(s) that may cause interference among the backscatter devices.

In some examples, a backscatter grant may indicate the identity/-ies of backscatter device(s) that are allowed to preform backscatter transmission, and respective time indications of time division multiple access (TDMA) transmission for the indicated backscatter device(s).

In some examples (e.g., when the backscatter device identity is unknown), scheduling information may comprise random access parameters (e.g., the size of a contention window from which a random slot count parameter must be drawn) for backscatter transmission. Then, the backscatter devices may be configured to decrement their slot counter according to some suitable rule and to perform backscatter transmission only when the slot counter is zero.

Yet alternatively or additionally, the control information may comprise time synchronization information. Such control information may be suitable for enabling backscatter device(s) to synchronize to the time system (e.g., OFDM timing) used by the device transmitting the signal packet for illumination and/or by the device receiving the backscatter transmission.

For example, the control information may comprise a time base counter. When the control information is provided using OOK and Manchester coding, the periodically occurring edges of the Manchester code may serve as a time base counter.

Yet alternatively or additionally, the control information may specify (e.g., comprise) one or more timing parameters for a transmission instance of the backscatter transmission. The timing parameter(s) may be specified in relation to the time synchronization information according to some embodiments.

A transmission instance may, for example, be a symbol (e.g., a bit) duration of the backscatter transmission. When the backscatter transmission is implemented using OOK, a transmission instance may be an ON-period (e.g., corresponding to a symbol, or half a symbol if Manchester coding is applied).

For example, the timing parameter(s) may include one or more of: a transmission instance start time, a transmission instance end time, and a transmission instance duration.

In some embodiments, the timing parameter(s) for a transmission instance of the backscatter transmission define the transmission instance as coinciding with one or more (typically consecutive) symbols for the reception channel. This approach can serve to facilitate reception of the backscatter transmission.

For example, when the device configured to receive the backscatter transmission is an OFDM receiver, the transmission instance may correspond to one or more OFDM symbols. In such approaches, the timing parameter(s) may define the transmission instance as coinciding with the one or more OFDM symbols, with an error margin which is less than the duration of the cyclic prefix (CP) of an OFDM symbol.

In addition to being indicative of the control information, the signal packet may be configured to trigger circuitry of the backscatter device for operation. The backscatter device circuitry triggering may be achieved according to any suitable approach. For example, the backscatter device may be configured to power up responsive to reception of electromagnetic energy, and start to receive some suitable control data, wherein the control data indicates whether or not the backscatter device should continue processing for backscatter transmission (if not, the backscatter device could power down, or continue to harvest energy, as suitable).

Alternatively or additionally, in addition to being indicative of the control information, the signal packet may be configured to transfer energy to the backscatter device. The energy transfer may be achieved using any suitable approach.

For example, at least a part of the signal packet (e.g., one or more illuminating portion(s) and/or one or more data portion(s), as will be exemplified later herein) may comprise one or more continuous wave(s) for transferring energy to the backscatter device.

When the device transmitting the signal packet is an OFDM transmitter, the one or more continuous wave may comprise at least one continuously active sub-carrier for transferring energy to the backscatter device.

In some embodiments, at least two continuous waves (e.g., at least two continuously active sub-carriers) are used for transferring energy to the backscatter device. This may be particularly beneficial to avoid being subject to restrictive power constraints for single tone transmission and/or to increase the amount of energy that can be transferred when there is a limit imposed on power spectral density (PSD).

In some embodiments, a sub-carrier for transferring energy is not continuously active, but comprises some other content suitable for energy transfer.

Yet alternatively or additionally, in addition to being indicative of the control information, the signal packet may be configured to illuminate the backscatter device to cause backscatter transmission by the backscatter device. Typically, the illumination causes the backscatter transmission to be performed within a duration of an illuminating portion of the signal packet and/or in accordance with the control information. The illumination may be achieved using any suitable approach.

For example, one or more illuminating portion(s) of the signal packet may comprise one or more (e.g., two or more) continuous wave(s) for illumination of the backscatter device. When the device transmitting the signal packet is an OFDM transmitter, the one or more continuous wave may comprise at least one (e.g., at least two) continuously active sub-carrier for illumination of the backscatter device. In some embodiments, a sub-carrier for illumination is not continuously active, but comprises some other content suitable for illumination.

When the device transmitting the signal packet is also configured to receive the backscatter transmission (e.g., for an STR MLD or a partial in-band full duplex OFDM device), the method 100 may further comprise receiving the backscatter transmission in response to transmitting the signal packet, as illustrated by optional step 190. In the scenario of an STR MLD, the reception of the backscatter transmission is typically within the reception channel of the MLD (which may, or may not, be a channel suitable for OFDM signaling). In the scenario of a partial in-band full duplex OFDM device, the reception of the backscatter transmission is typically for one or more OFDM signal sub-carriers of the channel.

In some embodiments, the method 100 may further comprise providing—to a device configured for reception of the backscatter transmission—information regarding time and/or frequency resources of the backscatter transmission. The provision of such information may typically be performed before execution of step 150.

In scenarios where channel sensing is suitable or required (e.g., listen-before-talk, LBT, scenarios), the method 100 may comprise sensing (e.g., using clear channel assessment, CCA, or any other suitable approach) the applicable channel before transmission of the signal packet, as illustrated by optional step 110.

According to such approaches, the signal packet may be transmitted (only) when the sensing indicates that a channel condition is fulfilled. This is illustrated by optional step 120. When the condition is fulfilled (Y-path out from step 120) the method 100 proceed towards transmission of the signal packet. When the condition is not fulfilled (N-path out from step 120) the method 100 does not proceed towards transmission of the signal packet. Instead, transmission of the signal packet may be aborted and/or a new channel sensing may be performed (as illustrated by the loop-back to step 110) to determine whether the channel condition is fulfilled at a later point in time.

The channel sensing, the channel condition, and the determination whether the channel condition is fulfilled may take any suitable form. For example, a signal level present in the sensed channel (or any other suitable interference metric) may be measured and compared to a signal level threshold (or any other suitable interference threshold), wherein it is determined that the channel condition is fulfilled when the measured value does not exceed the threshold. It should be noted that the value of this threshold is not necessarily the same as for a threshold used for conventional listen-before-talk sensing.

When the backscatter transmission is configured to fall within the same channel as the signal packet (e.g., for a partial in-band full duplex OFDM device), the channel sensing of step 110 may comprise sensing in that channel only.

When the backscatter transmission is configured to fall within another channel than the signal packet (e.g., for an STR MLD, or for an OFDM scenario where one OFDM device transmits the signal packet in one channel suitable for OFDM signaling and another OFDM device receives the backscatter transmission in another channel suitable for OFDM signaling), the channel sensing of step 110 may comprise sensing the channel for transmission (transmission channel) of the signal packet and/or the channel for backscatter transmission (reception channel).

Thus, in some embodiments, step 110 may comprise sensing the transmission channel and (at the same time; or only when the condition is fulfilled for the transmission channel) sensing the reception channel. In such approaches, the channel condition may relate to both of the transmission channel and the reception channel. For example, the method 100 may proceed towards transmission of the signal packet (Y-path out from step 120) only when the sensing indicates that both of the transmission channel and the reception channel fulfill a channel condition for backscattering. When step 120 is implemented via comparison to a threshold, the same—or different—threshold values may be applied for the transmission channel and the reception channel. For example, the channel condition for the reception channel may comprise that an interference metric measured for the reception channel during sensing falls below a backscatter interference threshold. It should be noted that the value(s) of the threshold(s) is (are) not necessarily the same as for a threshold used for conventional listen-before-talk sensing.

In some scenarios (e.g., scenarios where transmitting devices contend for the channel and/or LBT scenarios), the method 100 may—additionally or alternatively to channel sensing—comprise reserving the reception channel for backscatter transmission before transmitting the signal packet, as illustrated by optional step 130. The reservation of the reception channel may be implemented using any suitable approach.

For example, reserving the reception channel may comprise transmitting a message (e.g., a clear-to-send (CTS) message) in the reception channel. This approach may be suitable, for example, for a partial in-band full duplex OFDM device, and/or for an STR MLD, and/or for an OFDM scenario where one OFDM device transmits the signal packet in one channel suitable for OFDM signaling and another OFDM device receives the backscatter transmission in another channel suitable for OFDM signaling).

Alternatively or additionally, the device transmitting the signal packet may enter a sleep mode in relation to communication with other transceiver nodes (e.g., other OFDM transceivers, such as IEEE 802.11 stations) before transmitting the signal packet. Entering sleep mode in relation to communication with other transceiver nodes may be seen as an approach for implicit reception channel reservation provided that the other transceiver nodes are hindered from initiating transmissions during the sleep mode of the device transmitting the signal packet. This approach may be suitable, for example, when the device transmitting the signal packet is an IEEE 802.11 access point and the other transceiver nodes are IEEE 802.11 STAs.

As illustrated by optional step 140, the method 100 may, according to some embodiments, comprise beamforming the transmission of the signal packet in a predetermined direction. Thus, the backscatter device typically needs to be present in a direction which is approximately equal to the predetermined direction to be triggered and/or illuminated.

The beamforming approach may be beneficial for limiting the number of backscatter devices that are triggered/illuminated by the signal packet. Alternatively or additionally, the beamforming approach may be beneficial for increasing the range of the signal packet transmission (e.g., assuming unchanged transmission power), and/or reducing the transmission power requirements of the backscatter device.

A typical use case example for beamforming the transmission of the signal packet is a smartphone which can be used as a backscatter reader, wherein a smartcard (e.g., for bank transactions) needs to be applied in the vicinity of a certain area on one side of the smartphone (the predetermined direction) for reading. In this (and other) examples, the beamforming may also comprise focusing the energy of the signal packet at a predetermined distance from the transmitter of the signal packet (e.g., such that the smartcard needs to be applied very close to the smartphone to enable a bank transaction).

In embodiments where the transmission of the signal packet is beamformed in a predetermined direction, any channel sensing (compare with step 110) may be limited to the predetermined direction (and possibly adjacent direction(s)), which may improve overall channel utilization and/or increase the probability of sensing the channel as unoccupied.

FIG. 2 illustrates an example method 200 according to some embodiments. The method 200 is for a backscatter device.

As illustrated by step 250, the method 200 comprises receiving a signal packet from a device configured to transmit the signal packet for illumination of the backscatter device. As mentioned above, a device configured to transmit a signal packet for illumination may be an OFDM transmitter and/or an STR MLD. For example, the device configured to transmit the signal packet may be the device that performs the method 100 of FIG. 1, and step 250 of FIG. 2 may comprise receiving the signal packet transmitted in step 150 of FIG. 1.

When the signal packet is received from an OFDM transmitter, the signal packet is received within a channel suitable for OFDM signaling. When the signal packet is received from an STR MLD, the signal packet is received within a transmission channel of the MLD. As already mentioned, the transmission channel of the MLD may, or may not, be a channel suitable for OFDM signaling.

The signal packet is indicative of (e.g., comprises) control information regarding backscatter transmission (e.g., as described above in connection with FIG. 1). Other than that, the signal packet may have any suitable format. For example, the signal packet may correspond to the signal packet described later herein in connection with FIG. 6.

As mentioned above, the control information (and/or other portions of the signal packet) may, according to some embodiments, be provided using frequency shift keying (FSK), and/or on-off keying (OOK), and/or Manchester coding (MC).

The signal packet may be configured to trigger circuitry of the backscatter device for operation (e.g., to power up and/or start receiving the signal packet according to step 250).

The signal packet may also be configured to transfer energy to the backscatter device (e.g., as described above in connection with FIG. 1). Then, the method 200 may comprise harvesting energy from at least part of the signal packet, as illustrated by optional step 260. Energy harvesting may be performed using any suitable approach. For example, one or more temporary energy storing units (e.g., capacitors) of the backscatter device may be charged by the signal packet.

For example, energy may be harvested from one or more of: an initial portion (preamble portion and/or additional illumination portion), one or more illuminating portion(s), and one or more data carrying portion(s).

The signal packet may be also be configured to illuminate the backscatter device to cause backscatter transmission by the backscatter device (e.g., as described above in connection with FIG. 1).

As illustrated by optional step 290, the method 200 may also comprise performing backscatter transmission. The backscatter transmission may be performed according to any suitable approach (e.g., reflection and modulation of an illuminating signal provided by the signal packet).

The backscatter transmission may be received by the device transmitting the signal packet as illustrated by step 190 of FIG. 1, and/or may be received by another device configured to receive backscatter transmission.

Typically, the backscatter transmission may be performed within the duration of an illumination portion of the signal packet, and/or by using an illuminating signal of the signal packet (e.g., provided within the illumination portion).

The backscatter transmission may, for example, be performed using frequency shift keying (FSK), and/or on-off keying (OOK), and/or Manchester coding (MC).

The backscatter transmission is performed in accordance with the control information provided by (e.g., comprised in) the received signal packet.

When the control information comprises backscatter scheduling information, and/or a backscatter grant, and/or a backscatter device identity indicator, the performance of step 290 may be conditioned on such information. For example, performing backscatter transmission in accordance with the control information may comprise performing backscatter transmission only when so indicated by the backscatter scheduling information, and/or the backscatter grant, and/or the backscatter device identity indicator.

The control information may include a frequency indicator for backscatter transmission (e.g., as described above in connection with FIG. 1). When the backscatter transmission is performed in accordance with the frequency indicator, the backscatter transmission and its corresponding illuminating portion are typically non-overlapping in frequency.

For example, the backscatter transmission may fall within a reception channel of an MLD and/or within a channel suitable for OFDM signaling (which may, or may not, be the same channel as the channel within which the signal packet was received). When the backscatter transmission falls within a channel suitable for OFDM signaling, the frequency indicator may be configured to cause the backscatter transmission to coincide with one or more OFDM signal sub-carriers of the channel.

In some embodiments, the frequency indicator for the backscatter transmission defines a frequency shift in relation to an illuminating signal of the signal packet. Then, performing the backscatter transmission of step 290 may be comprise applying the frequency shift in relation to the illuminating signal of the signal packet (which may, typically, be comprised in an illuminating portion or the signal packet), as illustrated by optional sub-step 280.

Alternatively or additionally, the control information may comprise time synchronization information (e.g., as described above in connection with FIG. 1). Then, the method 200 may further comprise performing time synchronization based on time synchronization information comprised in the control information, as illustrated by optional step 270. The time synchronization may be performed for each signal packet, or more seldom. For example, when the control information is provided using OOK and Manchester coding, the periodically occurring edges of the Manchester code may serve as a time base counter and step 270 may comprise using the self-clocking properties of this signal to derive timing information.

Yet alternatively or additionally, the control information may specify (e.g., comprise) one or more timing parameters for a transmission instance of the backscatter transmission (e.g., as described above in connection with FIG. 1). Then, the backscatter transmission of step 290 may be performed according to the timing parameters specified by the control information.

For example, the backscatter transmission may be performed such that a transmission instance of the backscatter transmission coincides with one or more (typically consecutive) symbols for the reception channel within which the backscatter transmission is performed. When the reception channel is a channel suitable for OFDM signaling, the backscatter transmission may be performed such that a transmission instance of the backscatter transmission coincides with one or more OFDM symbols (e.g., with an error margin which is less than the duration of the cyclic prefix of an OFDM symbol).

FIG. 3 illustrates example signaling according to some embodiments. The example signaling of FIG. 3 is for a device configured to transmit a signal packet (TX; e.g., a device configured to perform the method 100 of FIG. 1) 301 and for a backscatter device (BSD; e.g., a device configured to perform the method 200 of FIG. 2) 303.

In some embodiments, the device 301 configured to transmit the signal packet may be comprised in a same device 300 as a device configured to receive backscatter transmission (RX) 302. For example, this may be applicable for an STR MLD and/or for a partial in-band full duplex OFDM device.

The signaling comprises a signal packet 351 being transmitted from the device 301 (compare with step 150 of FIG. 1) and received by the backscatter device 303 (compare with 250 of FIG. 2), thereby illuminating the backscatter device 303.

The signaling also comprises backscatter transmission 393 being performed by the backscatter device 303 (compare with step 290 of FIG. 2) and received by the device 302 (compare with 190 of FIG. 1), which may, or may not be compressed in the same device as the device 301 configured to transmit the signal packet.

In some embodiments, the signaling of FIG. 3 comprises sensing the applicable channel(s) before the signal packet 351 is transmitted (compare with step 110 of FIG. 1). Sensing of the channel within which the signal packet is to be transmitted may be performed by the transmitter device 301, as illustrated by 311. When the channel within which the backscatter transmission is to be performed is different from the channel within which the signal packet is to be transmitted, sensing of the channel within which the backscatter transmission is to be performed may also be performed; typically by the receiver device 303, as illustrated by 312.

Alternatively or additionally, the signaling of FIG. 3 may comprise reserving the reception channel (i.e., the channel within which the backscatter transmission is to be performed) for backscatter transmission before transmitting the signal packet (compare with step 130 of FIG. 1). The reservation of the channel within which the backscatter transmission is to be performed may be performed by the reception device 302, as illustrated by 332 (e.g., responsive to triggering 331 by the transmitter device 301).

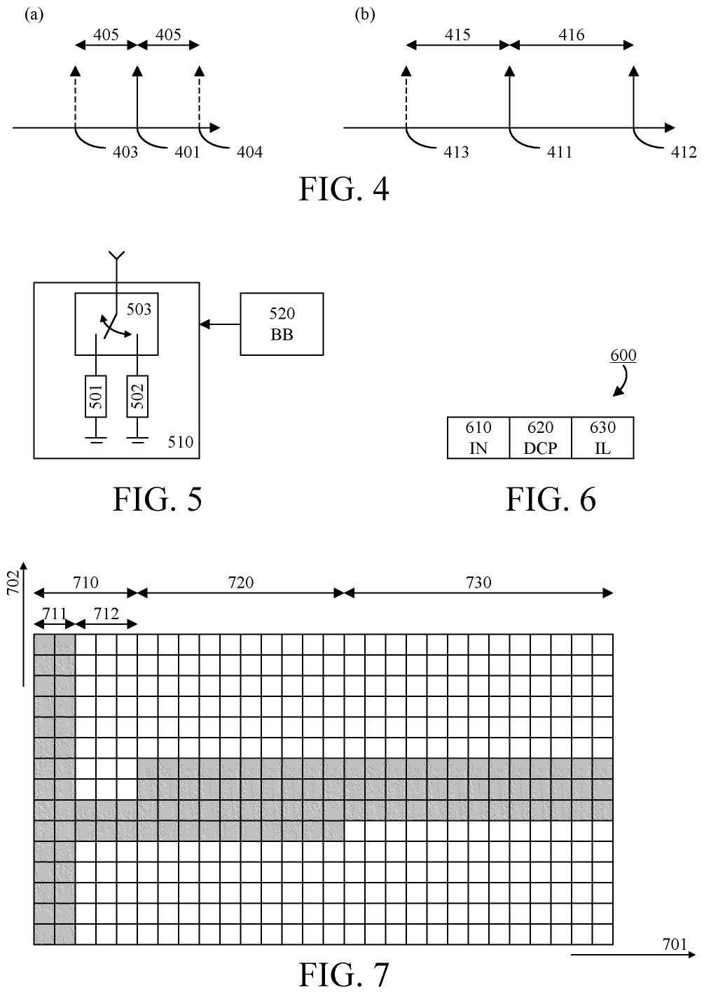

FIG. 4 schematically illustrates (using the frequency domain) two example frequency shift principles according to some embodiments. Any of the frequency shift principles illustrated in FIG. 4 may be applied for the frequency shift of the control information comprised in the signal packet (e.g., as elaborated on in connection with FIGS. 1, 2, and 6).

In part (a) of FIG. 4, a frequency shift 405 is illustrated in relation to an illuminating signal 401 (e.g., an illuminating signal of a signal packet). According to this frequency shift principle, application of the frequency shift 405 to the illuminating signal 401 causes two images 403, 404 of the illuminating signal to appear; one 403 with a negative frequency shift in relation to the illuminating signal 401, and one 404 with a positive frequency shift in relation to the illuminating signal 401. This frequency shift principle may be implemented according to any suitable approach (e.g., by mixing the illuminating signal with a signal having the frequency shift as carrier frequency, or by switching the illuminating signal at a frequency corresponding the frequency shift as further exemplified in connection with FIG. 5). The approach of part (a) of FIG. 4 may be particularly suitable when the frequency shift is relatively small compared to the frequency of the illuminating signal (e.g., when the channel within which the backscatter transmission is performed is the same as the channel within which the signal packet is transmitted; as is the case for a partial in-band full duplex device, for example).

In part (b) of FIG. 4, a frequency shift 415 is illustrated in relation to an illuminating signal 411 (e.g., an illuminating signal of a signal packet). According to this frequency shift principle, application of the frequency shift 415 to the illuminating signal 411 causes an image 413 of the illuminating signal 411 to appear at a frequency the corresponds to a frequency difference 416 between a further signal 412 (e.g., a second illuminating signal) and the illuminating signal 411. This frequency shift principle may be implemented according to any suitable approach (e.g., by the mixing approach described in “Dual frequency selective multiple access with quasi-chipless/powerless RFID mixer tags”, by Mandel, et al., IEEE microwave and wireless components letters, vol. 24, no. 8, August 2014, pp. 572-574). The approach of part (b) of FIG. 4 may be particularly suitable when the frequency shift is relatively large compared to the frequency of the illuminating signal(s) (e.g., when the channel within which the backscatter transmission is performed is different from the channel within which the signal packet is transmitted; as is the case for a an STR MLD, for example).

FIG. 5 schematically illustrates an example frequency shifting arrangement 510 according to some embodiments. For example, the frequency shifting arrangement 510 may be suitable for a backscatter device (e.g., comprisable in the backscatter device configured to perform the method 200 of FIG. 2). Alternatively or additionally, the frequency shifting arrangement 510 may be suitable for applying a frequency shift in relation to an illuminating signal (e.g., for execution of sub-step 280 of FIG. 2, and/or for implementation of the frequency shift 405 of FIG. 4).

The frequency shifting arrangement 510 comprises a switch 503 is operatively connected to an antenna via an antenna port, and is configured to alternate between application of a first impedance 501 and a second (different) impedance 502 between an antenna port and a reference potential (e.g., ground). The switch 503 may be implemented using any suitable approach for achieving a switching function.

A signal from a baseband (BB) 520 of the backscatter device may be used to determine the position of the switch 503, which in turn determines which of the impedances 501, 502 is connected to the antenna. If the signal from BB is a square wave, for example, while a reflected illuminating signal is applied for transmission via the antenna, the frequency shifting arrangement 510 may be seen as implementing a mixing between the reflected illuminating signal and the square wave. Thus, the frequency shifting arrangement 510 implements a frequency shift of the illuminating signal that corresponds to a switching periodicity (or toggling rate) used for the switch 503.

Further exemplification related to the frequency shifting arrangement 510 may be found in “A low-power backscatter modulation system communicating across tens of meters with standards-compliant Wi-Fi transceivers”, by Wang, et al., IEEE journal of solid-state circuits, vol. 55, no. 11, November 2020, pp. 2959-2969.

FIG. 6 schematically illustrates an example signal packet 600 according to some embodiments. The signal packet 600 is for illumination of a backscatter device. For example, the signal packet 600 may be the signal packet transmitted in step 150 of FIG. 1 and/or the signal packet received in step 250 of FIG. 2.

The signal packet may, for example, be for transmission by an OFDM transmitter within a channel suitable for OFDM signaling.

The signal packet comprises an initial portion (IN) 610, a data carrying portion (DCP) 620, and an illuminating portion (IL) 630. In some embodiments, the signal packet comprises two or more data carrying portions, each being directly followed by a respective illuminating portion.

The initial portion 610 is configured to trigger circuitry of the backscatter device for operation, and to transfer energy to the backscatter device.

The initial portion may comprise a preamble portion and/or an additional illuminating portion.

In some embodiments, the preamble portion and the additional illuminating portion are configured to (collectively) transfer an amount of energy to the backscatter device, wherein the amount of energy exceeds an energy threshold. Thus, a purpose of the additional illuminating portion may be to transfer energy in addition to an insufficient amount of energy transferrable by the preamble portion.

The preamble portion may, for example, comprise a legacy preamble (e.g., a legacy preamble as defined for IEEE 802.11). Alternatively or additionally, the preamble portion may be configured to cause other transmitters (e.g., other OFDM transmitters, such as IEEE 802.11 transmitters) to defer from transmission (at least in the channel where the signal packet was transmitted, and/or at least during the transmission of the signal packet).

In some embodiments, the preamble portion is configured to cause other transmitters to defer from transmission during a transmission opportunity (TXOP; e.g., a TXOP as defined for IEEE 802.11). Then, an approach may be used wherein only a first signal packet of the TXOP comprises the preamble portion.

When the signal packet is transmitted within a channel suitable for OFDM signaling, the preamble portion may extend over a predefined amount of frequency resources to enable interoperability with OFDM transceivers (e.g., to enable detection of the packet by OFDM receivers). For example, the preamble portion may extend over the entire channel except any guard bands.

The data carrying portion 620 is configured to provide control information to the backscatter device regarding backscatter transmission (e.g., as elaborated on in connection with FIGS. 1 and 2). In some embodiments, the data carrying portion may further comprise other information (e.g., data for backscattering devices and/or OFDM receivers).

For example, the data carrying portion may provide the control information using frequency shift keying (FSK), and/or on-off keying (OOK; e.g., multi-carrier OOK), and/or Manchester coding (MC).

The control information provided by the data carrying portion may comprise backscatter scheduling information, and/or a backscatter grant, and/or an identity indicator of one or more backscatter devices (e.g., the backscatter device(s) intended to use the signaling packet for backscatter transmission).

Alternatively or additionally, the control information provided by the data carrying portion may include (e.g., comprise) a frequency indicator for the backscatter transmission (e.g., as elaborated on in connection with FIGS. 1 and 2). The frequency indicator for the backscatter transmission may be configured to cause the backscatter transmission and its corresponding illuminating portion to be non-overlapping in frequency. Alternatively or additionally, the frequency indicator for the backscatter transmission may be configured to cause the backscatter transmission to coincide with one or more OFDM signal sub-carriers. In some embodiments, the frequency indicator for the backscatter transmission defines a frequency shift in relation to an illuminating signal of the corresponding illuminating portion.

Yet alternatively or additionally, the control information provided by the data carrying portion may comprise time synchronization information (e.g., as elaborated on in connection with FIGS. 1 and 2).

Yet alternatively or additionally, the control information provided by the data carrying portion may specify (e.g., comprise) one or more timing parameters (e.g., a transmission instance start time, and/or a transmission instance end time, and/or a transmission instance duration) for a transmission instance of the backscatter transmission (e.g., as elaborated on in connection with FIGS. 1 and 2). For example, the timing parameter(s) may define the transmission instance as coinciding (e.g., with an error margin of less than a CP) with one or more (typically consecutive) OFDM symbols.

The data carrying portion may, according to some embodiments, be further configured to transfer energy to the backscatter device. To this end, the data carrying portion may comprise at least one continuously active sub-carrier configured to transfer energy to the backscatter device. In some embodiments, a sub-carrier for transferring energy is not continuously active, but comprises some other content suitable for energy transfer.

When the signal packet is transmitted within a channel suitable for OFDM signaling, the data carrying portion typically (but not necessarily) extends only over a subset of the OFDM signal frequency resources of the channel (e.g., using only a subset of the OFDM signal sub-carriers of the channel).

The illuminating portion 630 is configured to cause backscatter transmission by the backscatter device within a duration of the illuminating portion and in accordance with the provided control information.

The illuminating portion may, according to some embodiments, be further configured to transfer energy to the backscatter device. To this end, the illuminating portion may comprise at least one continuously active sub-carrier configured to transfer energy to the backscatter device. In some embodiments, a sub-carrier for transferring energy is not continuously active, but comprises some other content suitable for energy transfer.

When the signal packet is transmitted within a channel suitable for OFDM signaling, the illuminating portion typically (but not necessarily) extends only over a subset of the OFDM signal frequency resources of the channel (e.g., using only a subset of the OFDM signal sub-carriers of the channel).

The subset of the OFDM signal frequency resources of the channel that are used by the illuminating portion may be the same, or a different, subset as that used by the data carrying portion. When different, the subset used by the illuminating portion may, or may not, be overlapping with the subset used by the data carrying portion. Alternatively or additionally, the number of frequency resources (e.g., sub-carriers) in the subset used by the illuminating portion may, or may not, be the same as the number of frequency resources in the subset used by the data carrying portion.

The number of frequency resources (e.g., sub-carriers) in the subset(s) used by the illuminating portion and the data carrying portion may be based on (e.g., limited by) one or more power constraint (e.g., regulatory conditions for allowable transmit power and/or power consumption constraints of the device transmitting the signal packet and/or a preference to use the same transmission power throughout the signal packet).

It should be noted that any feature described for the illuminating portion 630 may be equally applicable (when suitable) for the additional illuminating portion of the initial portion of the signal packet.

FIG. 7 schematically illustrates an example signal packet structure according to some embodiments, using a time-frequency grid where time 701 is represented horizontally and frequency is represented vertically 702. For example, the signal packet structure of FIG. 7 may be applicable for the signal packet transmitted in step 150 of FIG. 1 and/or the signal packet received in step 250 of FIG. 2 and/or the signal packet 600 of FIG. 6.

The signal packet structure comprises an initial portion 710, a data carrying portion 720, and an illuminating portion 730 (compare with 610, 620, 630 of FIG. 6). The initial portion 710 comprises a preamble portion 711 and (optionally) an additional illuminating portion 712.

The signal packet structure of FIG. 7 may, for example, be for transmission by an OFDM transmitter. Then, each horizontal unit of the time representation may correspond to an OFDM symbol and each vertical unit of the frequency representation may correspond to an OFDM signal sub-carrier of the applicable channel.

As illustrated by the gray time-frequency resources, the preamble portion 711 extends over all sub-carriers of the channel, the data carrying portion 720 extends only over a subset of the sub-carriers of the channel, and the illuminating portion 730 extends only over a subset of the sub-carriers of the channel (which is different than, but overlapping with the subset used by the data carrying portion 720). Further, the optional additional illuminating portion 712 extends only over a subset of the sub-carriers of the channel (which is different than, but overlapping with the subsets used by the data carrying portion 720 and the illuminating portion 730).

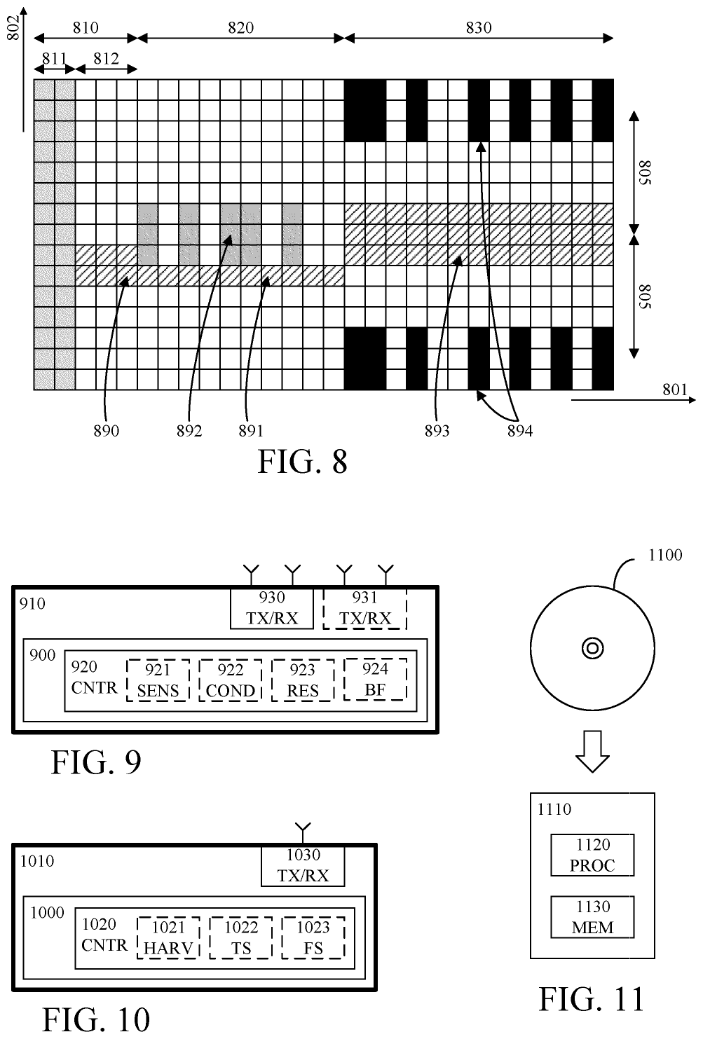

FIG. 8 schematically illustrates an example signal packet structure and an example corresponding backscatter transmission according to some embodiments, using a time-frequency grid where time 801 is represented horizontally and frequency is represented vertically 802. The illustration of FIG. 8 may be seen as an exemplification based on the signal packet structure of FIG. 7. Alternatively or additionally, the illustration of FIG. 8 may be applicable for the signal packet transmitted in step 150 of FIG. 1 and/or the signal packet received in step 250 of FIG. 2 and/or the signal packet 600 of FIG. 6. Yet alternatively or additionally, the illustration of FIG. 8 may be applicable for the backscatter transmission received in step 190 of FIG. 1 and/or the backscatter transmission performed in step 290 of FIG. 2.

The signal packet structure comprises an initial portion 810, a data carrying portion 820, and an illuminating portion 830 (compare with 610, 620, 630 of FIG. 6 and/or 710, 720, 730 of FIG. 7). The initial portion 810 comprises a preamble portion 811 and (optionally) an additional illuminating portion 812.

The signal packet structure of FIG. 8 may, for example, be for transmission by an OFDM transmitter. Then, each horizontal unit of the time representation may correspond to an OFDM symbol and each vertical unit of the frequency representation may correspond to an OFDM signal sub-carrier of the applicable channel.

The preamble portion 811 extends over all sub-carriers of the channel (represented by gray time-frequency resources within the preamble 811 portion).

The optional additional illuminating portion 812 extends only over a subset of the sub-carriers of the channel, and comprises two continuously active sub-carriers 890 (represented by striped time-frequency resources within the additional illuminating portion 812) for energy transfer.

The data carrying portion 820 extends only over a subset of the sub-carriers of the channel, and comprises control information 892 (e.g., provided using OOK, wherein the ON-periods are represented by gray time-frequency resources within the data carrying portion 820) and a continuously active sub-carrier 891 (represented by striped time-frequency resources within the data carrying portion 820; e.g., for energy transfer).

The illuminating portion 830 extends only over a subset of the sub-carriers of the channel, and comprises an illuminating signal 893 (represented by striped time-frequency resources within the illuminating portion 830) extending over three (e.g., continuously active) sub-carriers.

The backscatter transmission 894 (e.g., performed using OOK, wherein the ON-periods are represented by black time-frequency resources) occurs within the duration of the illuminating portion 830, is typically based on the illuminating signal 893 and may apply a frequency shift 805 in relation to the illuminating signal 893. As illustrated in FIG. 8, the control information 892 may cause the backscatter transmission 894 to coincide with the OFDM time-frequency grid, as elaborated on earlier herein.

FIG. 9 schematically illustrates an example apparatus 900 according to some embodiments. The apparatus 900 is for a device configured to transmit a signal packet for illumination of a (e.g., one or more) backscatter device.

As mentioned above, a device configured to transmit a signal packet for illumination may be an OFDM transmitter (e.g., an OFDM transceiver capable of simultaneous transmission and reception in a same channel, wherein the simultaneous transmission and reception use different OFDM signal frequency resources within the channel) and/or an STR MLD.

For example, the apparatus 900 may be comprisable (e.g., comprised) in the device 910 configured to transmit the signal packet. Example devices configured to transmit the signal packet include a radio access node (e.g., a base station—BS, a radio unit—RU, an access point—AP, etc.) and a user device (e.g., a user equipment—UE, a station—STA, etc.).

Alternatively or additionally, the apparatus 900 may be configured to cause performance of (e.g., perform) one or more of the method steps described on connection with FIG. 1.

The apparatus 900 comprises a controller (CNTR; e.g., controlling circuitry or a control module) 920.

The controller 920 is configured to cause transmission of a signal packet for illumination of a backscatter device (compare with step 150 of FIG. 1). The signal packet may have any suitable format. For example, the signal packet may correspond to the signal packet described in connection with FIG. 6.

To this end, the controller 920 may comprise, or be otherwise associated with (e.g., connectable, or connected, to) a transmitter; illustrated in the form of a transceiver (TX/RX; e.g., transceiving circuitry or a transceiver module) 930 in FIG. 9. The transceiver 930 may be configured to transmit the signal packet.

When the device transmitting the signal packet is also configured to receive the backscatter transmission, the controller 920 may also be configured to cause reception of the backscatter transmission in response to transmission of the signal packet (compare with step 190 of FIG. 1).

To this end, the controller 920 may comprise, or be otherwise associated with (e.g., connectable, or connected, to) a receiver; illustrated in the form of a transceiver (TX/RX; e.g., transceiving circuitry or a transceiver module) 930, 931 in FIG. 9. In the scenario of an STR MLD, the transceiver 931 receiving the backscatter transmission is typically different from the transceiver 930 transmitting the signal packet. In the scenario of a partial in-band full duplex OFDM device, the transceiver 930 receiving the backscatter transmission is typically the same transceiver 930 as the one transmitting the signal packet. In any case, the transceiver 930, 931 may be configured to receive the backscatter transmission.

In scenarios where channel sensing is suitable or required, the controller 920 may be configured to cause sensing of the applicable channel(s) (e.g., the channel within which the signal packet is to be transmitted and/or the channel within which the backscatter transmission is to be performed) before transmission of the signal packet (compare with step 110 of FIG. 1).

To this end, the controller 920 may comprise, or be otherwise associated with (e.g., connectable, or connected, to) a channel sensor (SENS; e.g., sensing circuitry or a sensor module) 921. The channel sensor 921 may be configured to sense the applicable channel(s) before transmission of the signal packet.

When sensing of the applicable channel(s) is performed, the controller 920 may be configured to cause the signal packet to be transmitted (only) when the sensing indicates that a channel condition is fulfilled (compare with step 120 of FIG. 1).

To this end, the controller 920 may comprise, or be otherwise associated with (e.g., connectable, or connected, to) a condition monitor (COND; e.g., condition monitoring circuitry or a condition monitor module) 922. The condition monitor 922 may be configured to determine whether the sensing indicates that the channel condition is fulfilled.

In some scenarios, the controller 920 may be configured to cause reservation of the reception channel for backscatter transmission before transmission of the signal packet (compare with step 130 of FIG. 1). The reservation of the reception channel may be implemented using any suitable approach (e.g., transmission of a CTS message in the reception channel and/or entering a sleep mode in relation to communication with other transceiver nodes).

To this end, the controller 920 may comprise, or be otherwise associated with (e.g., connectable, or connected, to) a channel reserver (RES; e.g., reserving circuitry or a reservation module) 923. The channel reserver 923 may be configured to reserve the reception channel (e.g., by causing transmission of a CTS message via a transceiver 930, 931 and/or by causing the device 910 to enter a sleep mode in relation to communication with other transceiver nodes).

The controller 920 may also be configured to cause beamforming of the transmission of the signal packet in a predetermined direction (compare with step 140 of FIG. 1).

To this end, the controller 920 may comprise, or be otherwise associated with (e.g., connectable, or connected, to) a beamformer (BF; e.g., beamforming circuitry or a beamformer module) 924. The beamformer 924 may be configured to beamform the transmission of the signal packet in the predetermined direction.

It should be noted that features and/or examples disclosed in connection with FIGS. 1-8 may be equally applicable for the description of FIG. 9; even if not explicitly mentioned in connection thereto.

FIG. 10 schematically illustrates an example apparatus 1000 according to some embodiments. The apparatus 1000 is for a backscatter device. For example, the apparatus 1000 may be comprisable (e.g., comprised) in a backscatter device 1010.

Alternatively or additionally, the apparatus 1000 may be configured to cause performance of (e.g., perform) one or more of the method steps described on connection with FIG. 2.

The apparatus 1000 comprises a controller (CNTR; e.g., controlling circuitry or a control module) 1020.

The controller 1020 is configured to cause reception of a signal packet from a device configured to transmit the signal packet for illumination of the backscatter device (compare with step 250 of FIG. 2).

To this end, the controller 1020 may comprise, or be otherwise associated with (e.g., connectable, or connected, to) a receiver; illustrated in the form of a transceiver (TX/RX; e.g., transceiving circuitry or a transceiver module) 1030 in FIG. 10. The transceiver 1030 may be configured to receive the signal packet.

The signal packet is indicative of (e.g., comprises) control information regarding backscatter transmission (e.g., as described above in connection with FIG. 1). Other than that, the signal packet may have any suitable format. For example, the signal packet may correspond to the signal packet described herein in connection with FIG. 6.

The controller 1020 may also be configured to cause performance of backscatter transmission in accordance with the control information (compare with step 290 of FIG. 2).

To this end, the controller 1020 may comprise, or be otherwise associated with (e.g., connectable, or connected, to) a transmitter; illustrated in the form of a transceiver (TX/RX; e.g., transceiving circuitry or a transceiver module) 1030 in FIG. 10. The transceiver 1030 may be configured to perform the backscatter transmission.

When the control information comprises a frequency indicator for the backscatter transmission that defines a frequency shift in relation to an illuminating signal of the signal packet, the controller 1020 may be configured to cause application of the frequency shift in relation to the illuminating signal when the backscatter transmission is performed (compare with sub-step 280 of FIG. 2).

To this end, the controller 1020 may comprise, or be otherwise associated with (e.g., connectable, or connected, to) a frequency shifter (FS; e.g., frequency shifting circuitry or a frequency shift module) 1023. The frequency shifter 1023 may be configured to apply the frequency shift in relation to the illuminating signal when the backscatter transmission is performed. In some embodiments, the frequency shifter 1023 may be implemented as (or configured to control) the frequency shifting arrangement 510 illustrated in FIG. 5.

In some embodiments, the controller 1020 may be configured to cause harvesting of energy from at least part of the signal packet (compare with step 260 of FIG. 2).

To this end, the controller 1020 may comprise, or be otherwise associated with (e.g., connectable, or connected, to) an energy harvester (HARV; e.g., energy harvesting circuitry or an energy harvest module) 1021. The energy harvester 1021 may be configured to harvest energy from at least part of the signal packet.

When the control information comprises time synchronization information, the controller 1020 may be configured to cause performance of time synchronization based on time synchronization information (compare with step 270 of FIG. 2).

To this end, the controller 1020 may comprise, or be otherwise associated with (e.g., connectable, or connected, to) a time synchronizer (TS; e.g., synchronizing circuitry or a synchronization module) 1022. The time synchronizer 1022 may be configured to perform time synchronization based on time synchronization information.

It should be noted that features and/or examples disclosed in connection with FIGS. 1-8 may be equally applicable for the description of FIG. 10; even if not explicitly mentioned in connection thereto.

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus such as an OFDM transmitter and/or an STR MLD, or a backscatter device.

Embodiments may appear within an electronic apparatus (such as an OFDM transmitter and/or an STR MLD, or a backscatter device) comprising arrangements, circuitry, and/or logic according to any of the embodiments described herein. Alternatively or additionally, an electronic apparatus (such as an OFDM transmitter and/or an STR MLD, or a backscatter device) may be configured to perform methods according to any of the embodiments described herein.

According to some embodiments, a computer program product comprises a non-transitory computer readable medium such as, for example, a universal serial bus (USB) memory, a plug-in card, an embedded drive, or a read only memory (ROM). FIG. 11 illustrates an example computer readable medium in the form of a compact disc (CD) ROM 1100. The computer readable medium has stored thereon a computer program comprising program instructions. The computer program is loadable into a data processor (PROC; e.g., a data processing unit) 1120, which may, for example, be comprised in an OFDM transmitter and/or an STR MLD, or a backscatter device, 1110. When loaded into the data processor, the computer program may be stored in a memory (MEM) 1130 associated with, or comprised in, the data processor. According to some embodiments, the computer program may, when loaded into, and run by, the data processor, cause execution of method steps according to, for example, any of the methods illustrated in FIGS. 1 and 2, or otherwise described herein.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

1. A method for an orthogonal frequency division multiplex (OFDM) transmitter, the method comprising:
transmitting a signal packet for illumination of a backscatter device, the signal packet comprising:
an initial portion configured to trigger circuitry of the backscatter device for operation, and configured to transfer energy to the backscatter device;
at least one data carrying portion configured to provide control information to the backscatter device regarding backscatter transmission; and
at least one illuminating portion configured to cause backscatter transmission by the backscatter device within a duration of the illuminating portion and in accordance with the provided control information.

2-8. (canceled)

9. The method of claim 1, wherein at least one illuminating portion comprises at least one continuously active sub-carrier.

10. The method of claim 1, wherein at least one illuminating portion extends only over a subset of OFDM signal frequency resources.

11. (canceled)

12. The method of claim 1, wherein the control information provided by the data carrying portion includes a frequency indicator for the backscatter transmission.

13. The method of claim 12, wherein the frequency indicator for the backscatter transmission is configured to cause the backscatter transmission and a corresponding illuminating portion to be non-overlapping in frequency.

14. The method of claim 12, wherein the frequency indicator for the backscatter transmission is configured to cause the backscatter transmission to coincide with at least one orthogonal frequency division multiplex (OFDM) signal sub-carrier.

15. (canceled)

16. (canceled)

17. The method of claim 1, wherein the control information provided by the data carrying portion specifies at least one timing parameter for a transmission instance of the backscatter transmission.

18. The method of claim 17, wherein the at least one timing parameter for a transmission instance of the backscatter transmission includes at least one of a transmission instance start time, a transmission instance end time and a transmission instance duration.

19. The method of claim 17, wherein the at least one timing parameter for a transmission instance of the backscatter transmission defines the transmission instance as coinciding with at least one OFDM symbol.

20-23. (canceled)

24. A method for a backscatter device, the method comprising:
receiving a signal packet from an orthogonal frequency division multiplex (OFDM) transmitter, the signal packet comprising:
an initial portion configured to trigger circuitry of the backscatter device for operation, and configured to transfer energy to the backscatter device;
at least one data carrying portion configured to provide control information to the backscatter device regarding backscatter transmission; and
at least one illuminating portion configured to cause backscatter transmission by the backscatter device within a duration of the illuminating portion and in accordance with the provided control information; and
harvesting energy from at least the initial portion.

25. The method of claim 24, wherein one or both of the at least one illuminating portion and the data carrying portion is further configured to transfer energy to the backscatter device.

26. (canceled)

27. The method of claim 24, further comprising performing time synchronization based on time synchronization information comprised in the control information provided by the data carrying portion.

28. The method of claim 24, further comprising performing backscatter transmission within the duration of the illuminating portion.

29. The method of claim 28, wherein the backscatter transmission is performed using at least one of frequency shift keying (FSK), on-off keying (OOK), and Manchester coding (MC).

30. The method of claim 28, wherein the backscatter transmission is performed in accordance with a frequency indicator included in the control information provided by the data carrying portion.

31-34. (canceled)

35. The method of claim 1, wherein the OFDM transmitter is an OFDM transceiver configured for simultaneous transmission and reception in a same channel, wherein the simultaneous transmission and reception use different OFDM signal frequency resources within the channel.

36-59. (canceled)

60. An apparatus for an orthogonal frequency division multiplex (OFDM) transmitter, the apparatus comprising:
controlling circuitry configured to cause transmission of a signal packet for illumination of a backscatter device, the signal packet comprising:
an initial portion configured to trigger circuitry of the backscatter device for operation, and configured to transfer energy to the backscatter device;
at least one data carrying portion configured to provide control information to the backscatter device regarding backscatter transmission; and
at least one illuminating portion configured to cause backscatter transmission by the backscatter device within a duration of the illuminating portion and in accordance with the provided control information.

61. The apparatus of claim 60, wherein at least one illuminating portion comprises at least one continuously active sub-carrier.

62. The apparatus of claim 60, wherein the apparatus is comprised on an orthogonal frequency division multiplex (OFDM) transmitter.

63-66. (canceled)

67. An apparatus for a backscatter device, the apparatus comprising controlling circuitry configured to:
cause reception of a signal packet from an orthogonal frequency division multiplex (OFDM) transmitter, the signal packet comprising:
an initial portion configured to trigger circuitry of the backscatter device for operation, and configured to transfer energy to the backscatter device;
at least one data carrying portion configured to provide control information to the backscatter device regarding backscatter transmission; and
at least one illuminating portion configured to cause backscatter transmission by the backscatter device within a duration of the illuminating portion and in accordance with the provided control information; and
harvest energy from at least the initial portion.

68-70. (canceled)
